(19) United States
(12) Patent Application Publication
(10) Pub. No.: US 2006/0230892 A1
(43) Pub. Date: Oct. 19, 2006

(54) BANANA CHIP MAKER

(76) Inventor: Carlos Osuna, Santa Barbara, CA (US)

Correspondence Address: LAURA N. TUNNELL, P.O. BOX 91929, SANTA BARBARA, CA, 93190, US

(21) Appl. No.: 11/161,350

(22) Filed: Jul. 29, 2005

Related U.S. Application Data
(60) Provisional application No. 60/594,519, filed on Apr. 14, 2005.

(51) Int. Cl. B26D 1/553

(52) U.S. Cl. 83/13; 30/117

(57) ABSTRACT

A one-handed culinary utensil for slicing bananas is described. The utensil comprises a base and an upper portion. The base comprises a handle and a lower jaw wherein the handle is contiguous with the lower jaw. The upper portion comprises a spring loaded lever and an upper jaw, the spring loaded lever being contiguous with the upper jaw. The upper portion is pivotally connected to the base such that the spring loaded lever is connected to the upper jaw and the lower jaw at a common point and the spring loaded lever is operable for rotating the upper jaw with respect to the lower jaw. The upper jaw comprises a substantially unshaped frame wherein a plurality of cutting wires are stretched across the u-shaped frame and the lower jaw comprises a bed shaped to receive and support the curved contour of a banana.

The culinary relationship between human beings and the banana is insidiously woven in the evolutionary tree. Because the fruit of the banana is accessible by digital manipulation of its outer skin, the constraints of banana-eating are complementary to the skills of mammals with like-sized digital members. Consequently, bananas and digitally inclined mammals are natural partners. The banana was probably rooted in the culinary culture of the human being at its onset. The situation has changed little to this day.

Although equipped with its own natural serving dish, i.e., its skin, it is often desirable to prepare the banana for consumption in other settings. Baby food and banana creme pie are two examples that come to mind. Such preparation usually means that the banana fruit must be segmented. The diameter of a banana is such that it can easily be accommodated within a human mouth. Thus, the natural dimension for segmentation is along its length.

When slicing a banana in preparation for a bowl of cereal, fruit salad, or a food dehydrator, a common practice is to place a peeled banana on a cutting board or hold it in a bare hand while slicing it with a knife. While the first step requires more cleanup, the second step exposes the skin of the hand to the blade of the knife. For professional chefs constrained by the demands of volume and time, such problems are exacerbated.

U.S. Pat. No. 5,035,056 discloses a frame designed to enclose the perimeter of a prone banana. A plurality of cutting members traverse the frame so that slices are formed therebetween as the frame is lowered over the banana.

Although the '056 patent addresses some of the issues discussed above, the design allows slices to get caught between cutting members. Moreover, the endless varieties of bananas sizes and shapes impose a limit on its utility. Numbering in excess of 300, some of the more exotic and desirable culinary varieties are indeed of a shape and texture quite unlike those commonly available to the public and cannot be accommodated by the above cited device. In addition, the '056 device is not a desirable alternative in settings wherein the need to handle large volumes of food in a small amount of time is paramount.

### SUMMARY

It is an object of the present invention to provide a tool particularly adapted to slice bananas.

It is another object of the present invention to provide a tool adapted to slice a banana in a plurality of segments with a single, one-handed operation of the tool.

It is another object of the present invention to provide a tool adapted to slice a banana that retains the overall banana shape for decorative purposes.

It is another object of the present invention to provide a tool that meets the above-noted objectives, is simple to use and is relatively easy and inexpensive to manufacture.

The foregoing and other objects and advantages are attained by a one-handed culinary utensil for slicing bananas, wherein the utensil comprises a base and an upper portion. The base comprises a handle and a lower jaw wherein the handle is contiguous with the lower jaw. The upper portion comprises a spring loaded lever and an upper jaw, the spring loaded lever being contiguous with the upper jaw. The upper portion is pivotally connected to the base such that the spring loaded lever is connected to the upper jaw and the lower jaw at a common point and the spring loaded lever is operable for rotating the upper jaw with respect to the lower jaw. The upper jaw comprises a substantially unshaped frame wherein a plurality of cutting wires are stretched across the unshaped frame and the lower jaw comprises a bed shaped to receive and support the curved contour of a banana.

The features of the present invention can be best understood together with further objects and advantages by reference to the following description, and accompanying drawings.

### DETAILED DESCRIPTION OF THE PREFERRED EMBODIMENTS

### DESCRIPTION OF THE FIGURES

FIG. 1: Comparative renditions of the Banana Chip Maker. A realistic representation is illustrated in FIG. 1(a). A simple notional rendition is shown in FIG. 1(b).

FIG. 2: Comparative renditions of the Banana Chip Maker in an open position ready to receive a banana. A realistic representation in illustrated in FIG. 2(a)—the notional rendition is shown in FIG. 2(b).

FIG. 3: Detail of upper jaw. A top view is shown in 3(a), and an end-on view in FIG. 3(b).

FIG. 4: Detail of lower jaw. A top view is shown in 4(a), a side view in 4(c). Two end-on views are shown in FIGS. 4(b) and 4(d).

FIG. 5: Banana chip maker slicing a banana

### DESCRIPTION OF NUMERALS USED IN THE FIGURES

10—Banana Chip Maker

11—notional rendition of Banana Chip Maker

12—upper jaw

13—lower jaw

14—spring loaded lever for opening and closing of jaw

15—handle

16—pivot

30—U-shaped mounting hoop

31—void between cutting wires

32—cutting wires

33—tip of mounting hoop

40—base

41—contoured segments

42—inter-segmental spacing

50—banana

### DESCRIPTION OF THE PREFERRED EMBODIMENTS

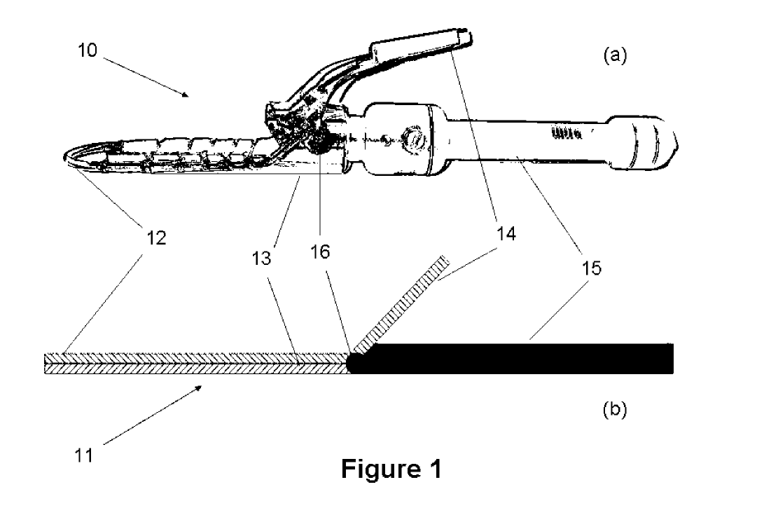

The banana chip maker (10), shown in FIG. 1, is essentially a wand (15) having jaws operable for being opened and closed by a spring loaded lever (14). The lever (14) is contiguous with the upper part of the jaw member (12) and pivotally connected to the lower jaw member (13) by a pivot member (16). A simplified, notional rendition of the banana chip maker (11) is correlated to the more realistic rendition (10) in the figure. Both renditions (10) and (11) show the jaws in a closed position.

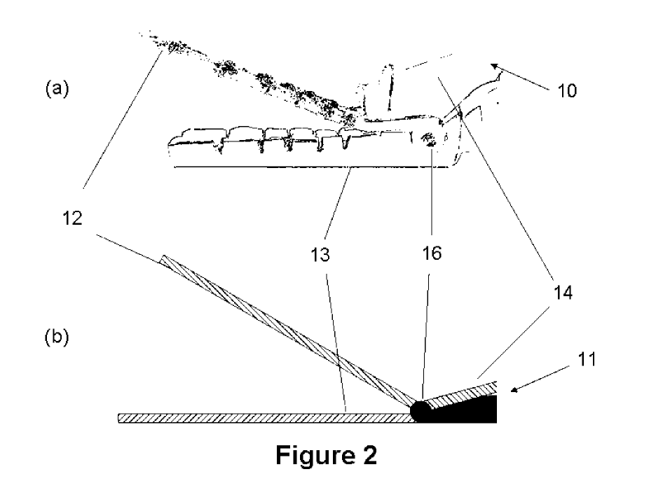

FIG. 2 again illustrates two renditions (10) and (11) of the banana chip maker in an open position, ready to receive the elongated dimension of a banana. The lever (14) has been depressed. By virtue of a fixed connection to the upper jaw member (12) and a pivotal connection (16) to the lower jaw member (13), the upper jaw rotates with respect to the lower jaw, and is thereby opened.

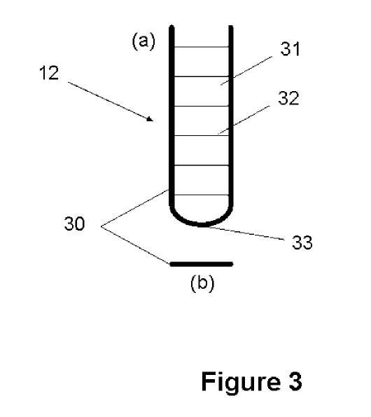

FIG. 3 illustrates several views of the upper jaw member (12) of the banana chip maker. A top view of the long dimension is shown in FIG. 3(a) and an end-on view in FIG. 3(b). The upper jaw member (12) is essentially a u-shaped hoop (30) with cutting wires (32) stretched transversely across its long dimension. The tip of the u-shaped hoop (33) may optionally be modified to function as a cutting member as well.

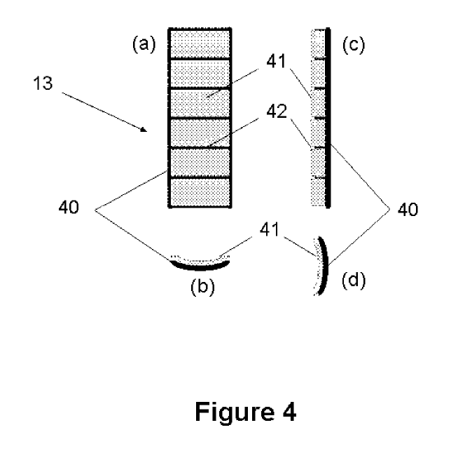

FIG. 4 illustrates several views of the lower jaw member (13) of the banana chip maker. A top view of the long dimension is shown in FIG. 4 (a) and a side view in FIG. 4 (c). Top and side views of the short dimension are shown in FIGS. 4( b) and 4 (d), respectively. The lower jaw member (13) comprises a plurality of segments (41) resting on a base plate (40) for structural support. Shaped to receive the lower contour of a banana, the location of the contoured segments (41) correspond to the void between the cutting wires (31) of the upper jaw member (12). The inter-segmental spacing (42) corresponds to the location of the cutting wires (32) of the upper jaw member (12) so that when the jaws are closed as shown in FIG. 1, the cutting wires (32) rest completely within the inter-segmental spaces (42) and below the upper surface of the contoured segments (41).

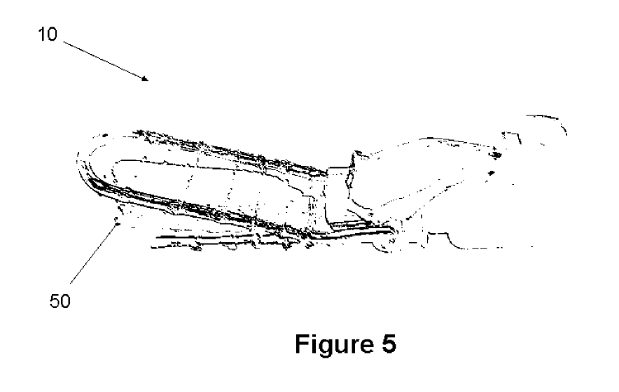

FIG. 5 show the banana chip maker (10) in the process of cutting a banana.

The Banana Chip Maker eliminates many physical steps in slicing a banana and eliminates the danger of a severe cut to the hand. The base section of the Banana Chip Maker allows the sliced banana to retain its distinctive, uncut shape, thus offering the user more options for decorative purposes. With only slight modifications, the basic design of the Banana Chip Maker can also serve as a template for similar utensils adapted to slice other foods such as cucumbers, celery sticks and the like.

What is claimed is:

1. A culinary utensil for slicing bananas adapted for single-handed operation, said utensil comprising:
A base and an upper portion,
wherein said base comprises a handle and a lower jaw,
said handle being contiguous with said lower jaw,
wherein said upper portion comprises a lever and an upper jaw,
said lever being contiguous with said upper jaw,
said upper portion being pivotally connected to said base such that said lever is connected to said upper jaw and said lower jaw at a common point and said lever is operable for enabling rotation of said upper jaw with respect to said lower jaw,
said upper jaw comprising a substantially u-shaped frame wherein a plurality of cutting wires are stretched across said u-shaped frame,
and said lower jaw comprising a bed shaped to receive and support a curved contour of a banana.

2. A one-handed method of slicing bananas said method comprising:
Presenting a culinary utensil as in claim 1,
grasping said handle and depressing said lever to open said upper jaw,
Inserting a banana between said upper jaw and said lower jaw,
Closing said upper jaw against said lower jaw while allowing said cutting wires to penetrate a fruit portion of said banana.
